(19) United States
(12) Patent Application Publication
(10) Pub. No.: US 2008/0248741 A1
(43) Pub. Date: Oct. 9, 2008

(54) TIME DIFFERENCE OF ARRIVAL BASED ESTIMATION OF DIRECTION OF TRAVEL IN A WLAN POSITIONING SYSTEM

(76) Inventor: Farshid ALIZADEH-SHABDIZ, Wayland, MA (US)

Correspondence Address: WILMERHALE/BOSTON, 60 STATE STREET, BOSTON, MA, 02109, US

(21) Appl. No.: 11/696,833

(22) Filed: Apr. 5, 2007

(51) Int. Cl. H04H 1/00; H04Q 7/20

(52) U.S. Cl. 455/3.02; 455/456.1

(57) ABSTRACT

Methods of estimating the bearing of a WLAN-enabled device are provided. A method of estimating a bearing of a WLAN-enabled device includes estimating a speed and geographic location of the device and receiving signals transmitted by an access point, including a first message and a second message. The method further includes accessing a database to determine the geographic location of the access point, determining an actual time of arrival value of the second message, and determining a time difference of arrival value for the second message based on the actual time of arrival of the second message and an expected time of arrival of the second message, which is based on an actual arrival time of the first message. Estimating the bearing of the device is based on the estimated speed and location of the device, the time difference of arrival value, and the location of the access point.

### CROSS-REFERENCE TO RELATED APPLICATIONS

This application is related to the following U.S. Patent Application No. TBA, filed on an even date herewith, entitled Time Difference of Arrival Based Estimation of Speed in a WLAN Positioning System, the contents of which are herein incorporated by reference.

### BACKGROUND OF THE INVENTION

1. Field of the Invention

The invention generally relates to using Time Difference Of Arrival (TDOA) to estimate speed, bearing (direction of travel), and location of WLAN enabled mobile devices in a WLAN based positioning system and, more specifically, utilizing the TDOA of packets from the same WLAN access point to estimate speed and bearing of a WLAN enabled mobile device. The invention also includes increasing the accuracy of location, speed, and bearing estimation by combining the results of TDOA based estimations with Received Signal Strength (RSS) based detenninations of location, speed and bearing of the WLAN enabled mobile device using a WLAN based positioning system.

2. Description of Related Art

With the proliferation of private and public WiFi networks in recent years, a positioning system based on WiFi networks was introduced for metro areas, which includes indoor and outdoor position estimation. In a wide-area WiFi positioning system, the location and characteristics of WiFi access points are used to locate WiFi enabled mobile devices. The various positioning models fall into three main categories: Received Signal Strength (RSS), Time of Arrival (TOA), or Angle of Arrival (AOA).

There are no current efforts in the research community or commercial enterprises to use TDOA or TOA for a metro area WLAN positioning systems. One paper, Royta Ymasaki and et. al. “TDOA Location System for IEEE 802.11b WLAN” Proc. WCNC 2005, pp 2338-2343, March 2005, considers using TDOA or TOA technology for indoor localization. In addition, another paper, A. Catovic and Z. Sahinoglu “Hybrid TOA/RSS and TDOA/RSS location estimation schemes for short range wireless networks” Mitsubishi Electric Research Lab, TR2004-096, December 2004, propose hybrid TOA/RSS and TDOA/RSS location estimation schemes for indoor location estimation. However, these references assume a need for a synchronized network of WiFi access points. A synchronized network means there exists a central reference clock and the timing of all the access points are exactly the same. The synchronization is easy to achieve for small size networks as in a corporate WLAN environment. In the case of a WiFi positioning system for metro areas using existing public and private WiFi access points, synchronizing the entire network is not possible and even for municipal networks (a city wide WiFi network installed and managed by one entity) the technique is very difficult to achieve, and none are known to exist. Therefore, TDOA from different access points or TOA is not used.

Metro wide WLAN based positioning systems have been explored by a couple of research labs, but none of them use the TDOA technique. The most important research efforts in this area have been conducted by PlaceLab (www.placelab.com, a project sponsored by Microsoft and Intel), University of California San Diego ActiveCampus project (ActiveCampus—Sustaining Educational Communities through Mobile Technology, technical report #CS2002-0714), and the MIT campus wide location system.

There have been a number of commercial offerings of WiFi location systems targeted at indoor positioning. (See, e.g., Kavitha Muthukrishnan, Maria Lijding, Paul Havinga, Towards Smart Surroundings: Enabling Techniques and Technologies for Localization, Proceedings of the International Workshop on Location and Context-Awareness (LoCA 2005) at Pervasive 2005, May 2005, and Hazas, M., Scott, J., Krumm, J.: Location-Aware Computing Comes of Age, IEEE Computer, 37(2):95-97, February 2004 005, Pa005, Pages 350-362.) These systems are designed to address asset and people tracking within a controlled environment like a corporate campus, a hospital facility or a shipping yard. The classic example is having a system that can monitor the exact location of the crash cart within the hospital so that when there is a cardiac arrest the hospital staff doesn't waste time locating the device. The accuracy requirements for these use cases are very demanding, typically calling for 1-3 meter accuracy. These systems use a variety of techniques to fine tune their accuracy including conducting detailed site surveys of every square foot of the campus to measure radio signal propagation. They also require a constant network connection so that the access point and the client radio can exchange synchronization information similar to how A-GPS works. While these systems are becoming more reliable for indoor use cases, they are ineffective in any wide-area deployment. It is impossible to conduct the kind of detailed site survey required across an entire city and there is no way to rely on a constant communication channel with 802.11 access points across an entire metropolitan area to the extent required by these systems. Most importantly, outdoor radio propagation is fundamentally different than indoor radio propagation, rendering these indoor positioning algorithms almost useless in a wide-area scenario.

FIG. 1 depicts a WiFi positioning system (WPS). The positioning system includes positioning software [103] that resides on a computing device [101]. Throughout a particular target geographical area, there are fixed wireless access points [102] that broadcast information using control/common channel broadcast signals. The client device monitors the broadcast signal or requests its transmission via a probe request. Each access point contains a unique hardware identifier known as a MAC address. The client positioning software receives signal beacons from the 802.11 access points in range and calculates the geographic location of the computing device using characteristics from the signal beacons. Those characteristics include the unique identifier of the 802.11 access point, known as the MAC address, Time of Arrival (TOA), and the strengths of the signal reaching the client device. The client software compares the observed 802.11 access points with those in its reference database [104] of access points, which may or may not reside on the device as well. The reference database contains the calculated geographic locations and power profile of all the access points the gathering system has collected. The power profile may be generated from a collection of readings that represent the power of the signal from various locations. Using these known locations, the client software calculates the relative position of the user device [101] and determines its geographic coordinates in the form of latitude and longitude readings. Those readings are then fed to location-based applications such as friend finders, local search web sites, fleet management systems and E911 services.

### BRIEF SUMMARY OF THE INVENTION

The invention provides methods and systems for estimating the direction of travel of a WLAN-enabled device in a WLAN positioning system.

Under one aspect of the invention, a method of estimating a direction of travel of a WLAN-enabled device includes estimating a speed of travel of the WLAN-enabled device and estimating a geographic location of the WLAN-enabled device. The method also includes the WLAN-enabled device receiving signals transmitted by a WLAN access point in range of the WLAN-enabled device. The signals include a first message and a second message. The method further includes accessing a reference database to determine the geographic location of the WLAN access point, determining an actual time of arrival value of the second message, and determining a time difference of arrival value for the second message based on the actual time of arrival of the second message and an expected time of arrival of the second message. The expected time of arrival of the second message is based on an actual arrival time of the first message. The method also calls for estimating the direction of travel of the WLAN-enabled device based on the speed of travel of the WLAN-enabled device, the estimated geographic location of the WLAN-enabled device, the time difference of arrival value, and the geographic location of the WLAN access point. The first and second messages can be data packets. Estimating the expected time of arrival of the second message can be further based on an inter-frame spacing value.

Under another aspect of the invention, the method of estimating the direction of travel includes, for more than one WLAN access point in range of the WLAN-enabled device, estimating corresponding time difference of arrival values for messages received from the more than one WLAN access point and accessing a reference database to determine the geographic location of each of the more than one WLAN access points. For each time difference of arrival value corresponding to one of the more than one WLAN access points, the method includes estimating a corresponding direction of travel of the WLAN-enabled device based on the speed of travel of the WLAN-enabled device, the corresponding time difference of arrival values, and the geographic locations of the WLAN access points and estimating the direction of travel of the WLAN-enabled device based on the directions of travel corresponding to the more than one WLAN access points.

Under a further aspect of the invention, estimating the direction of travel of the WLAN-enabled device based on the directions of travel corresponding to the more than one WLAN access points includes finding the median value of the corresponding directions of travel.

Under yet another aspect of the invention, the method of estimating the direction of travel further includes, repetitively determining and monitoring the time difference of arrival values corresponding to the WLAN access points over a period of time and identifying time difference of arrival values associated with line of sight signal components based on the change in time difference of arrival values during the period of time. Determining the direction of travel of the WLAN-enabled device is based on the difference of arrival values associated only with line of sight signal components.

Under one aspect of the invention, the method of estimating the direction of travel also includes determining a plurality of time difference of arrival values based on signals transmitted by the WLAN access point during a window of time and estimating the direction of travel of the WLAN-enabled device based on the plurality of time difference of arrival values. The window of time is based on a maximum expected speed of the WLAN-enabled device and can be about 10 seconds, about 2 seconds, or about 1 second.

Under yet another aspect of the invention, determining the geographic location of the WLAN-enabled device can be based on the received signals transmitted by the WLAN access point and the geographic location of the WLAN access point, which can include at least one received signal strength of signals transmitted by the WLAN access point. Determining the geographic location of the WLAN-enabled device can be based on information from a Global Navigation Satellite System.

Under a further aspect of the invention, determining the speed of travel of the WLAN-enabled device can be based on the received signals transmitted by the WLAN access point and the geographic location of the WLAN access point, which can include at least one received signal strength of signals transmitted by the WLAN access point. Determining the speed of travel of the WLAN-enabled device can be based on information from a Global Navigation Satellite System and/or information from a Doppler system.

### BRIEF DESCRIPTION OF THE SEVERAL VIEWS OF THE DRAWINGS

In the drawings,

FIG. 1 illustrates an embodiment of a WiFi positioning system;

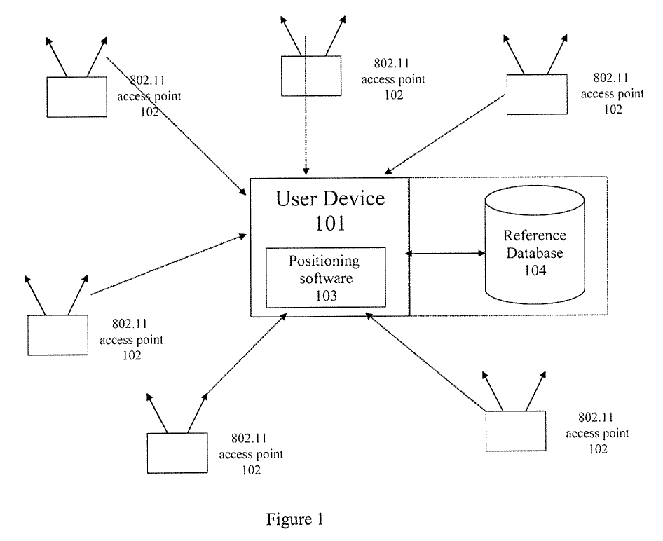

FIG. 2 illustrates that constant TDOA places a mobile device on a hyperbola;

FIG. 3 illustrates an example of D-TDOA system;

FIG. 4 illustrates an example of estimating TDOA for WiFi networks; and

FIG. 5 illustrates that the received signal by a mobile device is impacted by the multi-path effect.

### DETAILED DESCRIPTION OF THE INVENTION

Embodiments of the invention estimate speed and bearing of a WLAN enabled mobile device using the Time Difference Of Arrival (TDOA) of packets in a WLAN based positioning system. The WLAN based positioning system can be based on a synchronized network in which a reference clock and the time of all of the WLAN access points used for estimation is synchronized. In addition, the WLAN based positioning system can be based on a network without any time and clock synchronization between WLAN access points.

Embodiments of the invention can also estimate the speed and bearing of a WLAN enabled mobile device using Time Difference Of Arrival (TDOA) of packets from the same WLAN access point in a WLAN based positioning system. The time of arrival of consecutive packets are measured, and, based on a drift in the difference between the consecutive packets received from the same WLAN access point, the speed and bearing of a WLAN-enabled device are estimated. The WLAN based positioning system can be based on a synchronized network or it can be based on a network without any time and clock synchronization between WLAN access points.

Embodiments of the invention further include increasing the accuracy of location, speed, and bearing estimations by combining the results of TDOA based estimations of speed and bearing with Received Signal Strength (RSS) based determinations of location, speed and bearing of a WLAN-enabled mobile device using a WLAN based positioning system. RSS based estimation techniques for determining the location, speed, and bearing of a WLAN mobile device are described in greater detail below.

TDOA is defined in two different ways. One definition refers to the time difference between receiving packets, which were sent by different WLAN access points at the same time, herein referred to generally as “TDOA”. The second definition is the time difference between the times of arrival of multiple packets from the same WLAN access point. TDOA of packets from the same WiFi access point is referred to as “Drift-TDOA” or “D-TDOA” herein to distinguish over the traditional definition of TDOA. In order to calculate D-TDOA, the arrival time of a packet, or multiple packets, is used to calculate an expected arrival time of the next packet. The time difference between the expected time of arrival of the next packet and its actual time of arrival is determined; this is the D-TDOA of the later packet. If the expected time of arrival and the actual time of arrival of the later (or next) packet are denoted by TOAₑ and TOAₐ, respectively, the D-TDOA is calculated as follows:

D-TDOA=TOAₑ−TOAₐ

In a WiFi network, the expected time of arrival of the next packet is calculated based on the time of arrival of the last received packet (or packets) plus the transmission time, Inter Frame Spaces (IFS), and an integer number of time slots, as defined by the 802.1 1 standard (herein incorporated by reference). In other words, after receiving the last packet, the receiver can calculate the exact expected starting point of the time slots in which the next packet can arrive. If a WiFi enabled mobile device remains stationary, the arrival time of the next packet will be exactly at the beginning of a slot; if the WiFi enabled mobile device moves, there will be a time drift corresponding to its movement. That time drift is used to calculate a change in location.

Embodiments of the present invention build on techniques, systems and methods disclosed in earlier filed applications, including but not limited to U.S. patent application Ser. No. 11/261,848, entitled Location Beacon Database, U.S. patent application Ser. No. 11/261,898, entitled Server for Updating Location Beacon Database, U.S. patent application Ser. No. 11/261,987, entitled Method and System for Building a Location Beacon Database, and U.S. patent application Ser. No. 11/261,988, entitled Location-Based Services that Choose Location Algorithms Based on Number ofDetected Access Points Within Range of User Device, all filed on Oct. 28, 2005, and also including but not limited to U.S. patent application Ser. No. 11/430,224, entitled Calculation of Quality of WLAN Access Point Characterization for Use in a WLAN Positioning System, and U.S. patent application Ser. No. 11/430,222, entitled Estimation of Position Using WLAN Access Point Radio Propagation Characteristics in a WLAN Positioning System, both filed on May 8, 2006, the contents of which are hereby incorporated by reference in their entirety. Those applications taught specific ways to gather high quality location data for WiFi access points so that such data may be used in location based services to determine the geographic position of a WiFi-enabled device. The present techniques, however, are not limited to systems and methods disclosed in the incorporated patent applications. Thus, while reference to such systems and applications may be helpful, it is not believed necessary to understand the present embodiments or inventions.

Embodiments of the present invention also build on techniques, systems and methods disclosed in earlier filed applications, including but not limited to U.S. Patent Application No. U.S. patent application Ser. No. 11/430,079, entitled Estimation Of Speed and Direction of Travel In A WLAN Positioning System, U.S. patent application Ser. No. 11/429,862, entitled Estimation of Speed of Travel Using the Dynamic Signal Strength Variation of Multiple WLAN Access Points, U.S. patent application Ser. No. 11/430,064, entitled Estimation of Speed and Direction of Travel In A WLAN Positioning System Using Multiple Position Estimations, all filed on May 8, 2006, the contents of which are hereby incorporated by reference in their entirety. Those applications taught specific ways to determine the speed and direction of travel of a WiFi-enabled device in a WLAN positioning system. The present techniques, however, are not limited to systems and methods disclosed in the incorporated patent applications. Thus, while reference to such systems and applications may be helpful, it is not believed necessary to understand the present embodiments or inventions.

Embodiments of the invention also provide a system for and a method of continuously maintaining and updating speed and bearing estimation of a WLAN-enabled mobile device based on D-TDOA determinations, and also a method for detecting zero speed or stationary WLAN-enabled devices. The mobile device scans and detects public and private WLAN access points, logs D-TDOA corresponding to each of the WLAN access points, and uses that information to estimate or refine speed and bearing estimates of the mobile device.

If a WLAN mobile device is synchronized with a set of WLAN access points, the WLAN mobile device knows the departure time of the received signal. The synchronization of a WLAN mobile device with the WLAN network means synchronizing the reference clock and the reference time of the mobile device with the central time of the entire network. Therefore, because the exact departure time of the packet from the transmitter is known by the receiver (the user's mobile device) and the absolute travel time of the signal can be calculated as a result, the exact distance of the mobile device from the WLAN access point can be found. By knowing the distance from the WLAN access point and also the location of the WLAN access point, the location of WLAN enabled mobile device can be calculated given multiple access points.

In addition, a synchronized network of WiFi access points for a metro area is considered. This can be, for example, a synchronized municipal network. All the WiFi access points are configured to transmit a given signal (for example a beacon signal) at the given time, and a WiFi enabled mobile device calculates the TDOA of the received signal from different access points. TDOA is equal to the difference between the distances of the user from the access points divided by speed of light. Therefore, by measuring the TDOA values of packets departing from different access points at the synchronized time, a WiFi enabled mobile device can measure its distance from each access point.

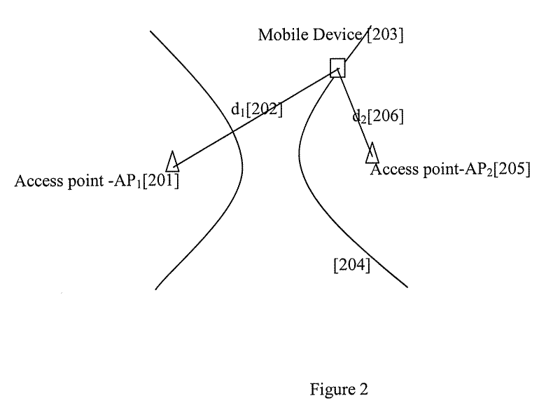

Referring to FIG. 2, the location of a mobile device with a constant difference of distance from two reference points is on a hyperbola. Therefore, by having at least three reference points, the exact location of the mobile device can be calculated. An example of two access points and a mobile device is shown in FIG. 2. The distance of a mobile device [203] from an access point AP₁ [201] is d₁ [202], and the distance of a mobile device [203] from an access point AP₂ [205] is d₂ [206]. By measuring the TDOA of signals from the two access points, the mobile device can calculate (d₁-d₂). Therefore, the location of mobile device can be anywhere on the hyperbola [204]. The RSS based methods incorporated above can be used in combination with this TDOA method to provide a coarse location estimation and improve the estimation results to avoid large errors due to multi-path signals.

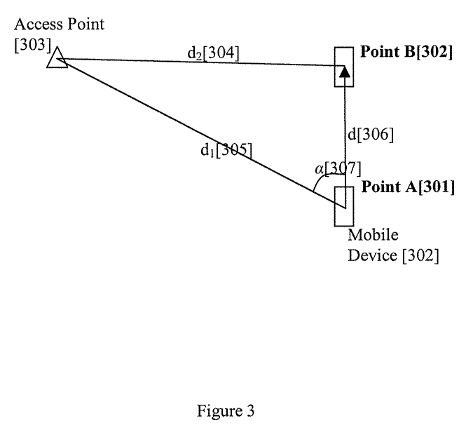

A wide-area WiFi positioning system leverages existing private and public WiFi access points, which do not operate in a coordinated or synchronized fashion. In this case, the TDOA between consecutive received packets from the same WiFi access point is calculated (i.e., D-TDOA). The drift in time of arrival of consecutive packets from the same access point, as defined above, is the D-TDOA value. Referring to FIG. 3, if a mobile device [302] moves from Point A [301] by a distance of d [306] to Point B [302], its distance from an access point [303] changes from d₁ [305] to d₂ [304]. Where the speed of light is denoted by C, the D-TDOA or Δtₛ is equal to

$$D - TDOA = Δ {t}_{s} = \frac{{d}_{1} - {d}_{2}}{C} .$$

If the speed of the mobile device is denoted by V, then

d=ΔAt

The time Δt is the travel time of the distance d. If the distance of movement is much smaller than the distance of the mobile device from the WiFi access point or (d <<d₁ and d₂), the following approximation holds true:

|d₁−d₂|=d×cos(α).

The parameter a[307] is the angle between the line connecting the mobile device to the access point [303] with the direction of travel.

Therefore, the speed of the mobile device can be estimated as follows:

$$V cos ( α ) = \frac{C Δ {t}_{s}}{Δ t} .$$

In some cases, the angle α [307] is known by the mobile device. For example, when a rough location estimate of the WLAN mobile device can be made using other methods, and the access point location is known, a can be calculated. In these cases, the speed of a mobile device can be calculated by detecting only one WiFi access point. If the angle α is not known, the mobile device computes Vcos(α) from the above equation for each detected WiFi access point. The value Vcos(α) is called the “speed reference” to a given access point. The speed reference to an access point is maximized when the angle α [307] is equal to zero or 180. Therefore, when the angle α [307] is not known, the maximum of multiple speed references to is selected as the best estimate of the speed of the mobile device.

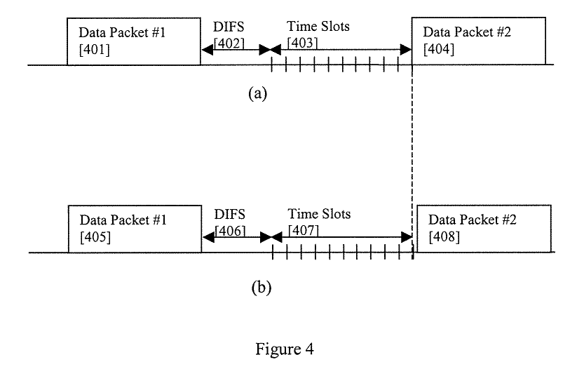

As introduced above, the expected time of arrival of a packet is calculated based on the exact time of arrival of the last packet plus Inter-Frame Space (IFS) timing as specified in the WiFi standard and the duration of an integer number of time slots. Slot duration is in the range of microseconds, while the deviation of packet arrival time due to the user's movement is in the range of nanoseconds. Therefore, nanosecond drift of time of arrival of a packet is considered due to the user movement. An example of two packets received from the same access point is shown in FIG. 4. In example (a) of the figure, packet number one [401] and packet number two [404] are apart in time by the end of the transmission time of the first packet plus the length of the DCF Inter-Frame Space [402] (herein “DIFS”) and the duration of an integer number of time slots [403] as defined in the WiFi standard.

Therefore, when the mobile device moves and the propagation delay changes, the second packet arrives not exactly inline with start of a time slot, as it is shown by the dashed line of example (b) of FIG. 4. In this example, a first packet [405] and a second packet [408] are apart in time from the end of the first packet [405] by the length of the DIFS [406], an integer number of slots [407], and also a small delay due to movement of the mobile device and the corresponding increase of the propagation delay between the mobile device and the access point.

The fact that a user is stationary is detected by receiving consecutive packets at the expected time of arrival (i.e. the start of one of the time slots), since there will be no drift due to user movement. The certainty of detection of stationary mobile devices increases as number of detected WiFi access points increases.

Under another embodiment, a method of determining the direction of travel of a WLAN enabled mobile device equipped with a reference database of WLAN access points in a target area is provided. The direction of travel is estimated by using geographical location information of WLAN access points in the reference database, an estimated location of the WLAN enabled mobile device (determined by, e.g., GPS, methods disclosed in the incorporated applications, or other methods), an estimated speed of travel of the mobile device, and an estimated speed of travel of the device relative to multiple access points (i.e. speed references).

If a mobile device determines its absolute speed of travel (e.g., by using Doppler, GPS, consecutive position estimations, or some other method) and also calculates its speed references to a number of access points (e.g., by using the D-TDOA techniques provided above), the device can calculate the angles, α, between the direction of travel and straight lines between the WiFi enabled mobile device and each detected WiFi access point. The angle α is calculated by dividing the speed reference to the access point (Vcos(α)) by the absolute speed of travel (V) and finding the cosine of α. The reference database is accessed to retrieve the corresponding geographical location information of the identified Wi-Fi access points. The geographical locations of the detected Wi-Fi access points, the angles, α, and the estimated location of the WLAN enabled mobile device are used to estimate the direction of travel.

Thus, the D-TDOA techniques and methods described above can be combined with Received Signal Strength (RSS) based techniques to increase the accuracy of location, speed, and bearing estimations of a WLAN enabled mobile device using a WLAN positioning system. In the combined method, the WLAN enabled mobile device scans for and detects public and private WLAN access points and logs both TDOA and RSS values corresponding to each of the detected WLAN access points. The RSS based techniques are used to estimate the location, speed and bearing of the WLAN enabled mobile device, and the D-TDOA methods are also used to estimate the speed and bearing independent of RSS values. These independent sets of values are then combined to provide location, speed, and bearing values of increased accuracy.

Also as mentioned above, the RSS based estimation of location, speed and bearing can be used by the D-TDOA based techniques as a rough estimate of speed and bearing. The system can then use these rough values to estimate more accurate speed and bearing determinations employing the D-TDOA methods. These improved speed and bearing values are then fed back to the system for use in further refining the location estimation, thereby also improving the location estimation.

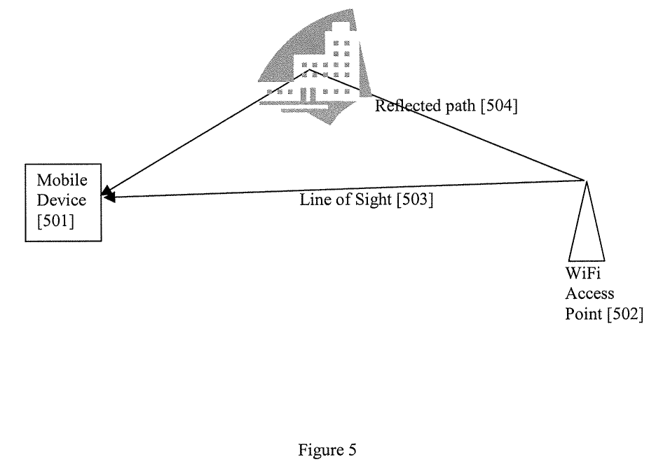

A WiFi positioning system operates in a multi-path environment. FIG. 5 provides an example of a mobile device [501 ] receiving two signals from the same WiFi access point

One signal is received directly from the WiFi access point [503], and the other one is received after reflecting off of a building [504]. Therefore, some measurements of TDOA and D-TDOA can be based on a multi-path component and not solely on the direct line of sight component of the received signal. The direction of arrival of a multi-path component is different than the direct line of sight component, because the multi-path component is a reflection of the signal from surrounding objects. In this case, the calculated angle, α, is between the direction of arrival of the multi-path component and the direction of travel. This component cannot be used to find an accurate direction of travel. If the bearing is calculated based on a multi-path component, the random nature of multi-path causes the bearing value to change randomly over time. Therefore, random change of the bearing or the history of movement of the mobile device can be used as criteria to detect this case and eliminate it from the bearing calculation

If a rough estimate of bearing is also available by using other methods (for example, by using consecutive location estimations), the bearing calculations based on multi-path components can also be detected. A mobile device can begin by considering the bearing values calculated for all the detected WiFi access points. Access point signals that arrive from paths other than direct lines of site from the corresponding WiFi access points can then be eliminated using the history of movement and coarse bearing calculations derived using other methods (e.g., such as those described in the incorporated applications). The final direction of travel is then calculated by combining all of the valid bearing samples. These valid bearing samples can be combined in different ways. For example, the median of samples can be considered as the final direction of travel.

Under at least one embodiment of the invention, the direct line of sight component of the signal is extracted by knowing a coarse bearing and a coarse speed. The coarse bearing is determined using a method other than one based on D-TDOA (e.g., such as those described in the incorporated applications). In order to determine the line of sight signal component, the bearings for the different multi-path components are calculated and compared to the coarse bearing information to determine which component among the various multi-path components is the line of sight component. The direct line of sight signal component is then used to calculate D-TDOA and/or TDOA, and, subsequently, the direct line of sight component is used to calculate location, speed and direction of travel of the WiFi mobile device.

The time of arrival of a signal is calculated based on the strongest received signal. However, the strongest received signal can be the direct line of sight signal or it can be a multi-path component. The D-TDOA is determined for both the direct line of sight component and the multi-path components, and these measurements are used to calculate the speed of travel as described above. If the time of arrival of the packets involved in the D-TDOA determination are calculated based on the same multi-path component, the expected time of arrival and the actual time of arrival are compared using the same reference point, and thus, those signals can be used to determine the D-TDOA.

However, there are cases when two different measurements of time of arrival are not based on the same multi-path component. In these cases, the D-TDOA is not a reliable indicator of the actual movement of the mobile device. These cases can be detected, as described above, by the resulting D-TDOA values from the various signal components and detecting large differences in the values.

With knowledge of the practical movement limitations of human carried devices, it can be assumed that the movement of a mobile device is negligible for the duration of Tₙ. The value of Tₙ depends on the mobility model of the mobile device, that is, the end use to which the device is put. For example, if the mobility model is that of a pedestrian, the duration of Tₙ can be ten seconds. However, if the device is to be used in an automobile, the duration of Tₙ is one to two seconds. The Tₙ period depends on the speed of the mobile device and its value can be also changed dynamically based on the estimation of speed of the mobile device.

By appropriately setting the value of Tₙ, the amount of movement during Tₙ can be known to be negligible. Therefore, all the packets received during the period of Tₙ can be used to calculate TDOA and D-TDOA to increase the accuracy of the estimation of the time of arrival. The accuracy of estimation is increased by considering multiple samples of TDOA or D-TDOA estimations, which are taken during the duration of Tₙ, instead of a single sample. Again, because the mobility of the mobile device during Tₙ is negligible, the estimation results for the duration of Tₙ are correlated. Therefore, combining the multiple estimation results determined during the duration of Tₙ increases the accuracy of overall estimation of TDOA or D-TDOA. For example, the estimation results can be averaged to reduce the impact of noise.

It will be appreciated that the scope of the present invention is not limited to the above-described embodiments, but rather is defined by the appended claims, and these claims will encompass modifications of and improvements to what has been described. For example, embodiments have been described as the mobile device performing many of the determinations of the values of TDOA, D-TDOA, speed, bearing, and location. However, embodiments of the invention can be implemented such that the mobile device gathers signal information from WiFi access points and transmits the information to a server system to make such determinations.

What is claimed is:

1. A method of estimating a direction of travel of a WLAN-enabled device, the method comprising:
estimating a speed of travel of the WLAN-enabled device;
estimating a geographic location of the WLAN-enabled device;
the WLAN-enabled device receiving signals transmitted by a WLAN access point in range of the WLAN-enabled device, the signals including a first message and a second message;
accessing a reference database to determine the geographic location of the WLAN access point;
determining an actual time of arrival value of the second message;
determining a time difference of arrival value for the second message based on the actual time of arrival of the second message and an expected time of arrival of the second message, the expected time of arrival of the second message being based on an actual arrival time of the first message;
estimating the direction of travel of the WLAN-enabled device based on the speed of travel of the WLAN-enabled device, the estimated geographic location of the WLAN-enabled device, the time difference of arrival value, and the geographic location of the WLAN access point.

2. The method of claim 1, further comprising:
for more than one WLAN access point in range of the WLAN-enabled device, estimating corresponding time difference of arrival values for messages received from the more than one WLAN access point;
accessing a reference database to determine the geographic location of each of the more than one WLAN access points;
for each time difference of arrival value corresponding to one of the more than one WLAN access points, estimating a corresponding direction of travel of the WLAN-enabled device based on the speed of travel of the WLAN-enabled device, the corresponding time difference of arrival values, and the geographic locations of the WLAN access points; and
estimating the direction of travel of the WLAN-enabled device based on the directions of travel corresponding to the more than one WLAN access points.

3. The method of claim 2, wherein estimating the direction of travel of the WLAN-enabled device based on the directions of travel corresponding to the more than one WLAN access points includes finding the median value of the corresponding directions of travel.

4. The method of claim 2, further comprising:
repetitively determining and monitoring the time difference of arrival values corresponding to the WLAN access points over a period of time; and
identifying time difference of arrival values associated with line of sight signal components based on the change in time difference of arrival values during the period of time;
wherein determining the direction of travel of the WLAN-enabled device is based on the difference of arrival values associated only with line of sight signal components.

5. The method of claim 1, further comprising:
determining a plurality of time difference of arrival values based on signals transmitted by the WLAN access point during a window of time; and estimating the direction of travel of the WLAN-enabled device based on the plurality of time difference of arrival values;
wherein the window of time is based on a maximum expected speed of the WLAN-enabled device.

6. The method of claim 5, wherein the window of time is about 10 seconds.

7. The method of claim 5, wherein the window of time is about 2 seconds.

8. The method of claim 5, wherein the window of time is about 1 second.

9. The method of claim 1, wherein the first and second messages are data packets.

10. The method of claim 1, wherein estimating the expected time of arrival of the second message is further based on an inter-frame spacing value.

11. The method of claim 1, wherein determining the geographic location of the WLAN-enabled device is based on the received signals transmitted by the WLAN access point and the geographic location of the WLAN access point.

12. The method of claim 11, wherein determining the geographic location of the WLAN-enabled device is further based on at least one received signal strength of signals transmitted by the WLAN access point.

13. The method of claim 1, wherein determining the geographic location of the WLAN-enabled device is based on information from a Global Navigation Satellite System.

14. The method of claim 1, wherein determining the speed of travel of the WLAN-enabled device is based on the received signals transmitted by the WLAN access point and the geographic location of the WLAN access point.

15. The method of claim 14, wherein determining the direction of travel of the WLAN-enabled device is further based on at least one received signal strength of signals transmitted by the WLAN access point.

16. The method of claim 1, wherein determining the speed of travel of the WLAN-enabled device is based on information from a Global Navigation Satellite System.

17. The method of claim 1, wherein determining the speed of travel of the WLAN-enabled device is based on information from a Doppler system.
